(19) United States
(12) Patent Application Publication
(10) Pub. No.: US 2026/0004553 A1
(43) Pub. Date: Jan. 1, 2026

(54) CORRECTION APPARATUS, CORRECTION METHOD, AND STORAGE MEDIUM

(71) Applicant: CANON KABUSHIKI KAISHA, Tokyo (JP)

(72) Inventors: MASASHI YAMAMOTO, Kanagawa (JP); TATSUYA TSUJI, Kanagawa (JP); TAISUKE NISHIO, Kanagawa (JP); NATSUKO SATO, Kanagawa (JP)

(21) Appl. No.: 19/248,162

(22) Filed: Jun. 24, 2025

(30) Foreign Application Priority Data
Jul. 1, 2024 (JP) 2024-106201

(51) Int. Cl. G06V 10/60; G06T 5/20; G06V 10/75; H04N 1/60

(52) U.S. Cl. CPC G06V 10/60; G06T 5/20; G06V 10/751; H04N 1/60

(57) ABSTRACT

A correction apparatus includes at least one mnernory storing instructions, and at least one processor that, upon execution of the stored instructions, cause the correction apparatus to function as, a fluctuation informnation acquisition unit configured to acquire fluctuation information related to fluctuation of an input image, a band selection unit configured to select a wavelength band related to a generation of an output irnage according to the fluctuation informnation, and an imnage processing unit configured to perform predetermined image processing on the input image based on the selected wavelength band to generate the output image.

### BACKGROUND

### Field of the Technology

The present disclosure relates to a correction apparatus, a correction method, and a storage medium.

### Description of the Related Art

For example, in a case where telephoto imaging of a vessel or an aircraft is performed in a use case of a surveillance camera for harbor surveillance or infrastructure surveillance, the visibility of an object is likely to decrease due to a fluctuation of an object image caused by uneven changes in the refractive index of the atmosphere (heat haze). The refractive index of the atmosphere depends on the wavelength of light and the state of the air such as the temperature in the air, the atmospheric pressure, the humidity, and the carbon dioxide concentration. For example, if the state of the air is constant, the refractive index of the atmosphere changes according to the length of the wavelength of light. Specifically, if the state of the air remains unchanged, the shorter the wavelength of light is, the greater the refractive index of the atmosphere is, and the more likely an image is to be influenced by a fluctuation.

As a technique for reducing such an influence of a fluctuation, a technique for smoothing a plurality of images successively captured in chronological order in the time direction is known. This technique, however, has an issue where, if a dynamic body is included in an object, blur occurs in an image portion of the dynamic body. In response, Japanese Patent Application Laid-Open No. 2012-90152 discusses a technique for switching an infrared light cut-off filter and a visible light cut-off filter and inserting either of the filters between an object and an imaging element according to the presence or absence of a fluctuation, thereby reducing blur in a dynamic body while reducing a decrease in the visibility of an image due to a fluctuation. As the visible light cut-off filter, a visible light cut-off filter that cuts off a wavelength band shorter than a certain wavelength band and transmits a long-wavelength band, or a band-pass filter that transmits only a particular wavelength band is known.

However, in the conventional art discussed in Japanese Patent Application Laid-Open No. 2012-90152, an image output in a case where visible light is cut off is displayed in black and white. There is also a case where information regarding the differences between colors becomes lost depending on the infrared reflection characteristics of an object. This may also lose information regarding characters. As described above, the conventional art discussed in Japanese Patent Application Laid- Open No. 2012-90152 can reduce a fluctuation, but may also increase the loss of color information.

### SUMMARY

The present disclosure is directed to reducing a fluctuation while also enabling a reduction in the loss of color information.

According to an aspect of the present disclosure, a correction apparatus includes at least one memory storing instructions, and at least one processor that, upon execution of the stored instructions, cause the correction apparatus to function as, a fluctuation information acquisition unit configured to acquire fluctuation information related to fluctuation of an input image, a band selection unit configured to select a wavelength band related to a generation of an output image according to the fluctuation information, and an image processing unit configured to perform predetermined image processing on the input image based on the selected wavelength band to generate the output image.

Further features of the disclosure will become apparent from the following description of exemplary embodiments with reference to the attached drawings.

### BRIEF DESCRIPTION OF THE DRAWINGS

FIGS. 1A and 1B are diagrams illustrating examples of configurations of an imaging apparatus including correction functions.

FIG. 2 is a flowchart illustrating a flow of a correction process.

FIG. 3 is a diagram illustrating examples of an input image and output images.

FIG. 4 is a diagram illustrating a spectral sensitivity characteristic of an imaging element.

FIG. 5 is a diagram illustrating an example of a graphical user interface (GUI).

FIGS. 6A and 6B are diagrams illustrating examples of configurations of an imaging apparatus including correction functions.

FIGS. 7A and 7B are diagrams illustrating an optical characteristic of an infrared cut-off filter.

FIG. 8 is a flowchart illustrating a flow of a correction process.

FIGS. 9A and 9B are diagrams illustrating optical characteristics of visible light cut-off filters.

FIGS. 10A and 10B are diagrams illustrating optical characteristics of band-pass filters.

### DESCRIPTION OF THE EMBODIMENTS

Exemplary embodiments according to the present disclosure will be described below with reference to the drawings. The following exemplary embodiments do not limit the present disclosure, and not all the combinations of the features described in the present exemplary embodiments are essential for a method for solving the issues in the present disclosure. The configurations of the exemplary embodiments can be appropriately modified or changed depending on the specifications of an apparatus to which the present disclosure is applied, or various conditions (the use conditions and the use environment). A configuration may be obtained by appropriately combining parts of the following exemplary embodiments. In the following exemplary embodiments, the same or similar components and the processing steps are designated by the same reference signs, and are not redundantly described.

A first exemplary embodiment is described taking as an example a case where telephoto imaging of a vessel or an aircraft is performed in a use case of a surveillance camera for harbor surveillance or infrastructure surveillance. In the present exemplary embodiment, a description is given of a correction apparatus that suitably corrects a phenomenon where the visibility of an object decreases due to a fluctuation of an object image caused by uneven changes in the refractive index of the atmosphere (heat haze), according to a scene.

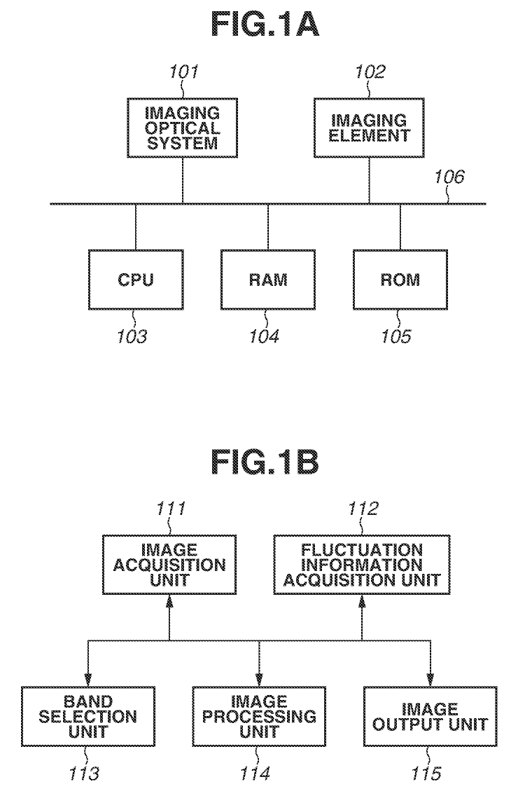

The first exemplary embodiment is described. FIG. 1A is a block diagram illustrating an example of the configuration of an imaging apparatus including the functions of a correction apparatus according to the present exemplary embodiment.

The imaging apparatus illustrated in FIG. 1A includes an imaging optical system 101, an imaging element 102, a central processing unit (CPU) 103, a random- access memory (RAM) 104, and a read-only memory (ROM) 105. These components are electrically connected together via a bus 106.

The imaging optical system 101 includes a lens group composed of one or more lenses and forms an image of incident tight on an imaging surface of the imaging element 102. As the lenses of the imaging optical system 101, a lens coated to change the transmittance of an infrared light component, a lens that reduces the influence of aberration, a lens that changes an optical characteristic, such as a teleconverter, and a lens having a different function with respect to each wavelength, such as a Neta lens, are used. The imaging optical system 101 may be an optical system built into the imaging apparatus, or may be an interchangeable lens attachable to and detachable from the imaging apparatus. Since the present exemplary embodiment takes the use case of the surveillance camera for harbor surveillance or infrastructure surveillance as an example, for example, the imaging optical system 101 includes a lens group capable of performing telephoto imaging of a vessel or an aircraft. In a case where telephoto imaging of a vessel or an aircraft is performed, as described above, the visibility of an object is likely to decrease due to a fluctuation of an object image caused by uneven changes in the refractive index of the atmosphere (heat haze).

The imaging element 102 captures an optical image of an object formed on the imaging surface by the imaging optical system 101. Specifically, the imaging element 102 generates image signals composed of a plurality of pixel signals obtained by digitally converting electric signals obtained by a plurality of photoelectric conversion elements arranged corresponding to respective pixels. In front of the imaging surface, color filters corresponding to red, green, and blue colors are provided, and the imaging element 102 captures an optical image passing through the color filters. Thus, the imaging element 102 outputs image signals including a red signal, a green signal, and a blue signal. The color filters transmit not only visible light components of red, green, and blue but also some infrared light components included in the invisible light region. Examples of the imaging element 102 can include a complementary metal-oxide- semiconductor (CMOS) and a charge-coupled device (CCD). Alternatively, a single- photon avalanche diode (SPAD) may be used as the imaging element 102. Since the present exemplary embodiment takes the use case of the surveillance camera for harbor surveillance or infrastructure surveillance as an example, the imaging element 102 outputs image signals of images of respective frames captured in chronological order, i.e., a moving image.

The CPU 103 is a central processing unit that performs overall control of the imaging apparatus.

The RAM 104 is a non-volatile memory and provides a work area used by the CPU 103 to execute processing. The RAM 104 also functions as a frame memory or functions as a buffer memory. The ROM 105 stores programs for the CPU 103 to control the imaging apparatus and data of an image. The programs stored in the ROM 105 also include a program for the CPU 103 to execute a correction process according to the present exemplary embodiment. The ROM 105 also stores, for example, several thresholds related to a fluctuation used in the correction process according to the present exemplary embodiment.

FIG. 1B is a block diagram illustrating the functional configuration of the correction apparatus included in the imaging apparatus according to the present exemplary embodiment. The correction apparatus according to the present exemplary embodiment acquires fluctuation information based on a captured image and selects a wavelength band related to image generation based on the fluctuation information, and thereby can generate an output image in which as much of color components (as much color information) as possible are left while a fluctuation on the image is reduced.

The correction apparatus according to the present exemplary embodiment includes functional units such as an image acquisition unit 111, a fluctuation information acquisition unit 112, a band selection unit 113, an image processing unit 114, and an image output unit 115. In the present exemplary embodiment, these functional units are achieved by reading the correction program according to the present exemplary embodiment stored in the ROM 105 into the RAM 104 and by the CPU 103 executing the correction program. These functional units may be achieved by a hardware component such as a circuit.

The image acquisition unit 111 acquires image signals (a so-called raw image) output from the imaging element 102 as an input image. The image acquisition unit 111 may acquire an image captured and recorded in the past, an image captured by another imaging apparatus, or an image acquired via a network as an input image.

The image processing unit 114 performs image processing for converting the values of the exposure, the luminance, and the colors of image signals output from the imaging element 102 to appropriate values, and image processing for correcting various types of aberration that occur in the imaging optical system 101 on the image signals. In the present exemplary embodiment, for example, the image processing unit 114 also performs processing for correcting a fluctuation by smoothing a plurality of images successive in chronological order in the time direction, and image processing corresponding to a wavelength band selected by the band selection unit 113.

The fluctuation information acquisition unit 112 acquires fluctuation information related to a fluctuation from an input image.

In the present exemplary embodiment, the fluctuation information acquisition unit 112 acquires fluctuation information based on an input image acquired by the image acquisition unit 111. For example, based on the magnitude of the difference in the pixel value of a pixel of interest between input images successive in chronological order, the fluctuation information acquisition unit 112 acquires fluctuation information indicating the magnitude of a fluctuation. The fluctuation information acquisition unit 112 in this case sets an edge portion of a stationary object in the input images as a pixel of interest, calculates the difference in the pixel value of the pixel of interest between the input images successive in chronological order as an amount of change, and acquires the amount of change as a fluctuation amount (fluctuation information). That is, the fluctuation information acquisition unit 112 acquires fluctuation information indicating a fluctuation amount such that if the amount of change in the pixel of interest between the input images successive in chronological order is great, the value of the fluctuation amount is great, and if the pixel of interest hardly changes, the value of the fluctuation amount is small.

Although in the above example, the difference in the pixel value of a pixel of interest between successive images is used as a fluctuation amount, the present disclosure is not limited to this. For example, the fluctuation information acquisition unit 112 may obtain the number of frames when the accumulated value of the difference between frames of input images successive in chronological order becomes greater than or equal to a predetermined value, as the cycle of a fluctuation, and acquire the cycle of the fluctuation as the amount of the fluctuation. The shorter the cycle of the fluctuation (i.e., the smaller the number of frames when the accumulated value of the difference between the frames becomes greater than or equal to the predetermined value) is, the greater the extent of the fluctuation is. Thus, the fluctuation information acquisition unit 112 acquires the cycle of the fluctuation as fluctuation information indicating a fluctuation amount.

For example, the fluctuation information acquisition unit 112 may acquire fluctuation information based on a value used in image processing performed by the image processing unit 114. For example, the fluctuation information acquisition unit 112 may acquire a correction value (a correction strength) obtained by the image processing unit 114 performing processing for correcting a fluctuation by smoothing a plurality of images successive in chronological order in the time direction, as fluctuation information.

For example, the fluctuation information acquisition unit 112 may calculate the proportion of an area where a fluctuation occurs in an input image, as a fluctuation occurrence probability, and acquire the fluctuation occurrence probability as fluctuation information indicating the amount of the fluctuation.

Further, for example, fluctuation information may include information regarding a notification in a case where the correction of a fluctuation is disabled based on at least either the lapse of time or an environment, or a notification in a case where there is a possibility that the correction of a fluctuation is disabled based on the result of an estimation regarding the fluctuation, such as an illuminance estimation.

Alternatively, for example, the fluctuation information acquisition unit 112 may acquire fluctuation information based on information input by a user through a graphical user interface (GUI) screen. Examples of the information input by the user through the GUI screen include information obtained by the user directly specifying the magnitude of a fluctuation or information specifying whether to give priority to the correction of a fluctuation or give priority to the reproduction of color information. The details of the GUI screen will be described below.

According to fluctuation information acquired by the fluctuation information acquisition unit 112 from an input image acquired by the image acquisition unit 111, the band selection unit 113 selects a wavelength band related to image generation when the image processing unit 114 at a subsequent stage generates an output image. In the present exemplary embodiment, the wavelength band related to the generation of the output image refers to a wavelength band to which the imaging element 102 has sensitivity, and refers to a band within the range from the visible light band (near 400 nm to 750 nm) to the invisible light band (near 750 nm to 1000 nm).

For example, if a fluctuation amount indicated by fluctuation information is greater than or equal to a predetermined threshold, the band selection unit 113 selects long-wavelength bands obtained by removing many short-wavelength bands likely to be influenced by a fluctuation. Although the details will be described below, if the fluctuation amount is great, for example, the band selection unit 113 selects, among a red signal, a green signal, and a blue signal constituting an input image, the wavelength band of the red signal obtained by removing the blue signal and the green signal on the short-wavelength band side likely to be influenced by a fluctuation. That is, if the fluctuation amount is great, the band selection unit 113 selects the wavelength band of the red signal of a long-wavelength band least likely to be influenced by a fluctuation from the wavelength bands of the input image. Similarly, although the details will be described below, for example, if the fluctuation amount is less than the predetermined threshold, the band selection unit 113 selects remaining wavelength bands obtained by removing some short-wavelength band among the wavelength bands of the input image. That is, if the fluctuation amount is small, the band selection unit 113 selects the wavelength bands of the green signal and the red signal from the wavelength bands of the input image and removes the blue signal of a short-wavelength band most likely to be influenced by a fluctuation.

Alternatively, the band selection unit 113 may select a wavelength band by changing the signal ratios of the red signal, the green signal, and the blue signal constituting the input image. For example, the band selection unit 113 may select a wavelength band related to the generation of an output image by changing the signal ratio of the blue signal of a short-wavelength band, such as changing the use of 100% of the blue signal to the use of 50% of the blue signal.

The image output unit 115 outputs an image after image processing is performed by the image processing unit 114 based on a wavelength band selected by the band selection unit 113, as an output image.

The image after the wavelength band is selected by the band selection unit 113 is an image obtained by removing the wavelength band of a blue signal or a green signal as described above, and therefore is an image having a color deviating from the color of the original input image. Thus, the image processing unit 114 performs, on the image after the wavelength band is selected by the band selection unit 113, processing for bringing the color deviating from that of the original input image close to the true color reproduction of the input image. If the wavelength band is selected by the band selection unit 113, there is a possibility that the resulting image is darker than the original input image due to a decrease in a signal component. Thus, the image processing unit 114 also performs processing for correcting the value of the exposure or the luminance corresponding to the amount of darkening due to the decrease in the signal component. The image output unit 115 outputs an image after the above image processing is performed by the image processing unit 114.

The image processing unit 114 can also generate an output image corresponding to a case where a wavelength band is not selected by the band selection unit 113. For example, if a wavelength band does not need to be selected because there is not a fluctuation, or if the user compares both an input image and an image after a wavelength band is selected on an operation screen of the imaging apparatus, the image processing unit 114 may output an image according to the input image.

Although FIG. 1B illustrates an example where the fluctuation information acquisition unit 112, the band selection unit 113, and the image processing unit 114 are separate functional units as the functional configuration of the correction apparatus, these units may be collectively implemented as a single functional unit. Alternatively, the image processing unit 114 may include both the functions of the fluctuation information acquisition unit 112 and the band selection unit 113. Yet alternatively, the image acquisition unit 111 and the image processing unit 114 may be collectively implemented as a single functional unit, or the image processing unit 114 and the image output unit 115 may be collectively implemented as a single functional unit. That is, since the functional units illustrated in FIG. 1B are achieved by executing the program on the CPU 103 (or an image processing engine (not illustrated)), the functional units can be appropriately integrated or divided.

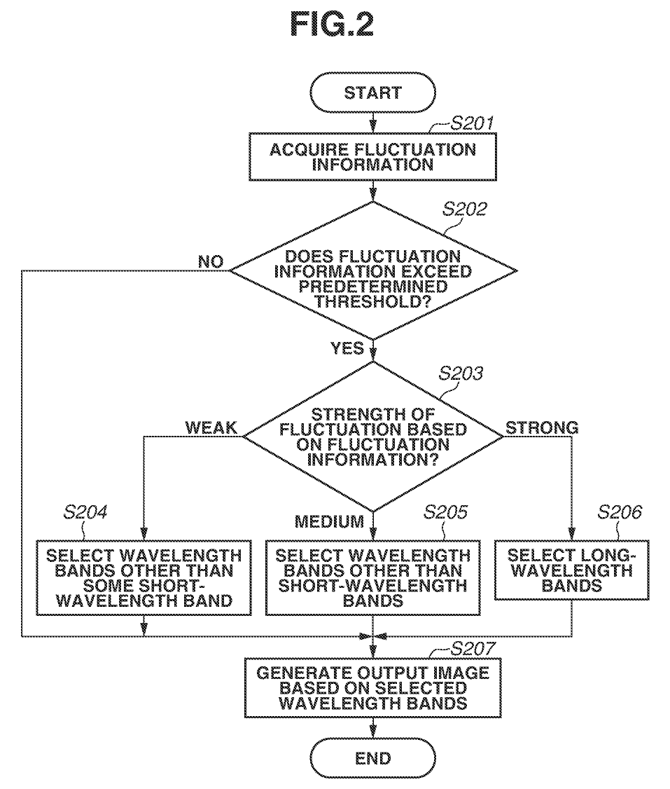

FIG. 2 is a flowchart illustrating the flow of the correction process performed by the correction apparatus included in the imaging apparatus according to the present exemplary embodiment. Processing steps described in this flowchart are achieved by, for example, the CPU 103 executing the correction processing program stored in the ROM 105.

First, in the process of step S201, the fluctuation information acquisition unit 112 acquires fluctuation information from an image. A description is given taking an example where the fluctuation information acquisition unit 112 acquires fluctuation information based on an input image acquired by the image acquisition unit 111. Based on input images in chronological order acquired by the image acquisition unit 111, the fluctuation information acquisition unit 112 acquires a fluctuation amount indicating the magnitude of a fluctuation in the input images as fluctuation information.

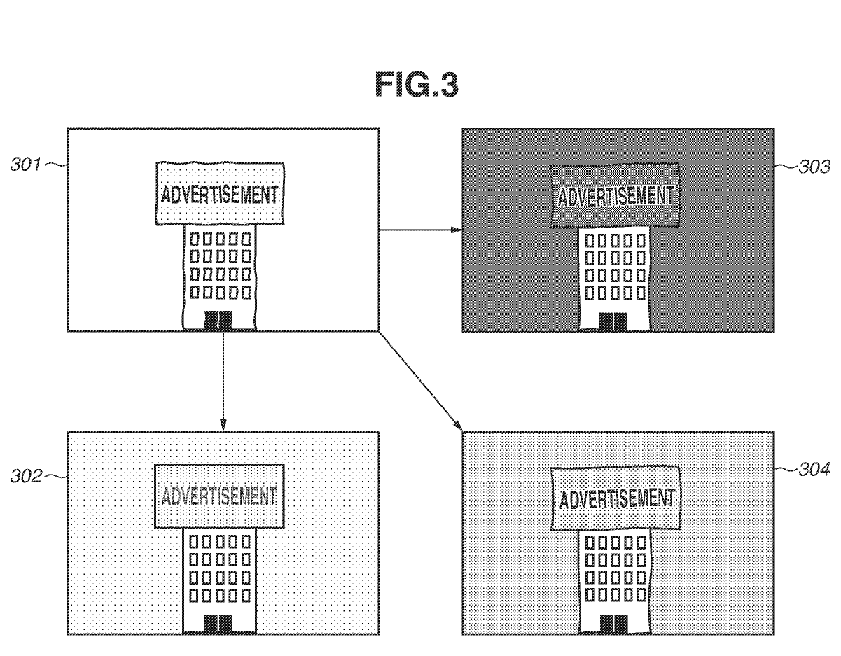

FIG. 3 is a diagram illustrating examples of an image of a scene where there is a fluctuation, and images as the results of correcting the fluctuation on the image of the scene. An image 301 in FIG. 3 is an example of an input image of a scene where a fluctuation occurs before the fluctuation is corrected. The image 301 illustrates an example where a fluctuation influenced by the refractive index of the atmosphere occurs in edge portions of a building, a signboard above the building, and a portion of characters "advertisement" in the signboard, and thus the portions that are originally straight appear distorted. The distorted portions in the image due to the fluctuation sequentially change in images of frames in chronological order. The fluctuation information acquisition unit 112 acquires the difference in the pixel value of a pixel of interest between input images in chronological order as fluctuation information indicating a fluctuation amount. If the fluctuation information acquisition unit 112 acquires fluctuation information in step S201, the processing proceeds to step S202.

In step S202, the fluctuation information acquisition unit 112 determines whether the fluctuation amount acquired as the fluctuation information in step S201 exceeds a predetermined amount threshold. If the fluctuation amount does not exceed the predetermined amount threshold (is less than or equal to the predetermined amount threshold) (No in step S202), the fluctuation information acquisition unit 112 determines that a fluctuation does not occur. Then, the processing proceeds to step S207. If, on the other hand, the fluctuation amount exceeds the predetermined amount threshold (Yes in step S202), the fluctuation information acquisition unit 112 determines that a fluctuation occurs. Then, the processing proceeds to step S203.

In step S203, based on the fluctuation information (the fluctuation amount) acquired in step S201, the fluctuation information acquisition unit 112 performs classification according to the strength of the fluctuation. The present exemplary embodiment takes an example where the strength of the fluctuation is classified into three levels, namely a fluctuation "weak", a fluctuation "medium", and a fluctuation "strong". The fluctuation information acquisition unit 112 classifies the strength of the fluctuation based on the comparison between two different classification thresholds set in advance for classification and the fluctuation amount. In this example, as the two classification thresholds for classification, a first classification threshold for dividing the fluctuation "weak" and the fluctuation "medium" and a second classification threshold for dividing the fluctuation "medium" and the fluctuation "strong" are set in advance.

The fluctuation information acquisition unit 112 compares the fluctuation amount acquired in step S201 and the first and second classification thresholds, thereby dividing the strength of the current fluctuation into any of the fluctuation "weak", the fluctuation "medium", and the fluctuation "strong". For example, if the fluctuation amount acquired by the fluctuation information acquisition unit 112 is less than the first classification threshold, the fluctuation information acquisition unit 112 classifies the strength of the fluctuation into the fluctuation "weak". If the fluctuation amount acquired by the fluctuation information acquisition unit 112 is greater than or equal to the first classification threshold and less than the second classification threshold, the fluctuation information acquisition unit 112 classifies the strength of the fluctuation into the fluctuation "medium". For example, if the fluctuation amount acquired by the fluctuation information acquisition unit 112 is greater than or equal to the second classification threshold, the fluctuation information acquisition unit 112 classifies the strength of the fluctuation into the fluctuation "strong". Then, if the strength of the fluctuation based on the fluctuation amount is the fluctuation "weal", the processing proceeds to step S204. If the strength of the fluctuation based on the fluctuation amount is the fluctuation "medium", the processing proceeds to step S205. If the strength of the fluctuation based on the fluctuation amount is the fluctuation "strong", the processing proceeds to step S206.

In step S204, the band selection unit 113 selects wavelength bands related to the generation of an output image corresponding to the case where the strength of the fluctuation is the fluctuation "weak" from the wavelength bands of each input image.

That is, in the case of the fluctuation "weak", the band selection unit 113 selects wavelength bands other than some short-wavelength band most likely to be influenced by a fluctuation among the wavelength bands of the input image. In other words, in the case of the fluctuation "weak", the band selection unit 113 selects wavelength bands obtained by removing some short-wavelength band most likely to be influenced by a fluctuation among the wavelength bands of the input image. Specifically, the band selection unit 113 selects, among a red signal, a green signal, and a blue signal constituting the input image, the wavelength bands of the green signal and the red signal obtained by removing the blue signal of a short-wavelength band most likely to be influenced by a fluctuation.

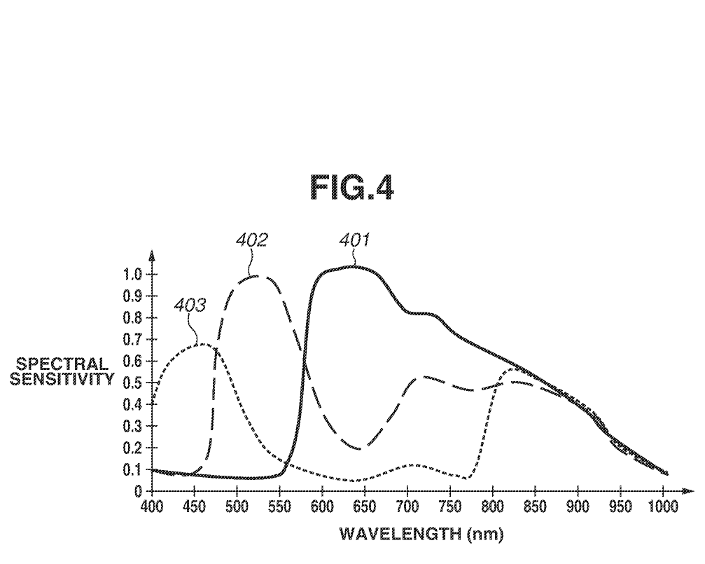

FIG. 4 is a diagram illustrating an example of the characteristic of the spectral sensitivity to the wavelength of light of the imaging element 102 of the imaging apparatus according to the present exemplary embodiment. The vertical axis represents the spectral sensitivity of the imaging element 102. The horizontal axis represents the wavelength of light received by the imaging element 102 in the range of 400 nm to 1000 nm. In FIG. 4, a spectral curve 401 drawn by a solid line indicates the spectral sensitivity of a red pixel having a peak near a wavelength of 630 nm. A spectral curve 402 drawn by a dashed line indicates the spectral sensitivity of a green pixel having a peak near a wavelength of 530 nm. A spectral curve 403 drawn by a dotted line indicates the spectral sensitivity of a blue pixel having a peak near a wavelength of 450 nm.

In step S204, the wavelength bands to be selected from among the wavelength bands of the input image by the band selection unit 113 in the case of the fluctuation "weak" are wavelength bands obtained by removing the spectral curve 403 of the blue pixel having a peak near a wavelength of 450 nr. That is, in the case of the fluctuation "weak", the band selection unit 113 selects a wavelength band indicated by the spectral curve 401 of the red pixel having a peak near a wavelength of 630 nm, and a wavelength band indicated by the spectral curve 402 of the green pixel having a peak near a wavelength of 530 nm. As described above, in step S204, the band selection unit 113 selects wavelength bands after a blue signal based on the spectral curve 403 on the short wavelength side is removed among image signals acquired by the imaging element 102, as the wavelength bands related to the generation of the output image. That is, the band selection unit 113 selects a red signal based on the spectral curve 401 and a green signal based on the spectral curve 402 among the image signals acquired by the imaging element 102, as the wavelength bands related to the generation of the output image. If the wavelength bands are selected in step S204, the processing proceeds to step S207.

As described above, the band selection unit 113 may select wavelength bands by changing the signal ratios of the red signal, the green signal, and the blue signal. That is, in step S204, the band selection unit 113 may reduce the signal ratio of the blue signal based on the spectral curve 403 on the short wavelength side when the output image is generated.

In step S205, the band selection unit 113 selects wavelength bands related to the generation of an output image corresponding to the case where the strength of the fluctuation is the fluctuation "medium" from the wavelength bands of the input image.

In the present exemplary embodiment, in the case of the fluctuation "medium", the band selection unit 113 selects wavelength bands other than the short-wavelength band removed in the case of the fluctuation "weak" and a part of the wavelength band of the green signal among the wavelength bands of the input image.

To give a description using the spectral sensitivity characteristic in Fig. 4, in the case of the fluctuation "medium", the wavelength bands to be selected from the wavelength bands of the input image by the band selection unit 113 are wavelength bands other than the wavelength bands of the spectral curve 403 of the blue pixel and a part of the spectral curve 402 of the green pixel. That is, in the case of the fluctuation "medium", the band selection unit 113 selects a wavelength band obtained by removing a part on the short wavelength side of the spectral curve 402 of the green pixel having a peak near a wavelength of 530 nm and the wavelength band indicated by the spectral curve 401 of the red pixel having a peak near a wavelength of 630 nm. In step S205, if the wavelength bands are selected, the processing proceeds to step S207.

Also in the case of the fluctuation "medium", the band selection unit 113 may select wavelength bands by changing the ratios of the blue signal, the green signal, and the red signal as described above. For example, in the case of the fluctuation "medium", the band selection unit 113 may set the ratio of the blue signal based on the spectral curve 403 to a ratio smaller than the signal ratio in the case of the fluctuation "weak". For example, in the case of the fluctuation "medium", the band selection unit 113 may remove the wavelength band of the blue signal of a short-wavelength band and then further reduce the signal ratio of the green signal based on the spectral curve 402 of the green pixel having a peak near a wavelength of 530 nm.

In step S206, the band selection unit 113 selects wavelength bands related to the generation of an output image corresponding to the case where the strength of the fluctuation is the fluctuation "strong" from the wavelength bands of the input image.

In the present exemplary embodiment, in the case of the fluctuation "strong", the band selection unit 113 selects the wavelength band of the red signal obtained by removing the blue signal and the green signal among the wavelength bands of the input image.

To give a description with reference to Fig. 4, in the case of the fluctuation "strong", the wavelength bands to be selected by the band selection unit 113 are the wavelength band indicated by the spectral curve 401 of the red pixel having a peak near a wavelength of 630 nm obtained by removing the spectral curve 403 of the blue pixel and the spectral curve 402 of the green pixel. Then, in step S206, if the wavelength bands are selected, the processing proceeds to step S207.

Also in the case of the fluctuation "strong", the band selection unit 113 may select wavelength bands by changing the ratios of the blue signal, the green signal, and the red signal similarly to the above. For example, in the case of the fluctuation "strong", the band selection unit 113 may set the ratio of the green signal based on the spectral curve 402 to a ratio smaller than the signal ratio in the case of the fluctuation "medium". For example, in the case of the fluctuation "strong", the band selection unit 113 may set the ratio of the blue signal based on the spectral curve 403 and the ratio of the green signal based on the spectral curve 402 to ratios smaller than the signal ratios in the case of the fluctuation "medium".

As described above, by any of steps S204 to S206, the band selection unit 113 selects wavelength bands in which the fluctuation is reduced in a stepwise manner relative to the amount of the fluctuation while as much color information regarding the input image as possible can be left, as the wavelength bands related to the generation of the output image. That is, the band selection unit 113 selects wavelength bands such that if the fluctuation amount is small, the loss of the color information is small. The band selection unit 113 selects wavelength bands such that the fluctuation amount becomes more reduced as the fluctuation amount becomes greater. As the fluctuation amount becomes greater, the color information also becomes gradually lost. The band selection unit 113, however, selects wavelength bands such that even if the fluctuation amount becomes greater, the color information remains. Wavelength bands in a case where the processing proceeds to step S207 after it is determined in step S202 that the fluctuation amount is less than or equal to the predetermined amount threshold are the wavelength bands of the input image. That is, the band selection unit 113 in this case selects the wavelength bands of the input image.

Although in the above example, the strength of the fluctuation is classified into three classifications, namely "weak", "medium", and "strong", the classifications of the strength of the fluctuation are not limited to three, and for example, may be two classifications or four or more classifications. No matter which classification is performed, the band selection unit 113 selects wavelength bands to leave a part of the color information.

In step S207 after step S204, S205, or S206, the image processing unit 114 performs a generation process for generating the output image based on the wavelength bands selected in step S204, S205, or S206. For example, if the strength of the fluctuation is the fluctuation "weak", the band selection unit 113 selects wavelength bands other than the wavelength band of the blue signal, or wavelength bands after the ratio of the blue signal is reduced. In this case, however, the fluctuation in the original input image is reduced, but the color of the image deviates by an amount corresponding to the removal of the wavelength band of the blue signal or by an amount corresponding to the reduction in the ratio of the blue signal, and the luminance or the exposure of the image also decreases. Thus, in step S207, based on the wavelength bands selected according to the amount of the fluctuation, the image processing unit 114 corrects the deviating color and corrects the luminance or the exposure. Then, the image output unit 115 outputs an image after the corrections as the output image.

For example, if the wavelength band of the blue signal is removed, or if the ratio of the blue signal is reduced, for example, the image processing unit 114 calculates the white balance gain again, thereby bringing the output image close to the color reproduction of the original input image. Since the luminance decreases due to the decrease in the signal, the image processing unit 114 adds an offset amount corresponding to the amount of the decrease in the signal. Alternatively, for example, the image processing unit 114 may fix the white balance and increase or decrease the white balance by an offset amount corresponding to the amount of change in the ratio of the signal, thereby bringing the output image close to the color reproduction of the original image. Even if the image processing unit 114 brings the output image close to the color reproduction of the original input image, there is a possibility that the color of the output image does not completely match the original color. Thus, there can also be a case where other functions of the color system are restricted from being used.

As described above, in the present exemplary embodiment, wavelength bands related to the generation of an output image are selected according to fluctuation information, whereby it is possible to leave color information while appropriately reducing a fluctuation. An image 303 in FIG. 3 illustrates an example of an output image generated based on signals of wavelength bands selected in the case of the fluctuation "strong" in the correction apparatus according to the present exemplary embodiment from the image in which there is a fluctuation illustrated in the image 301. An image 304 in FIG. 3 illustrates an example of an output image generated based on signals of wavelength bands selected in the case of the fluctuation "medium" in the correction apparatus according to the present exemplary embodiment from the image in which there is a fluctuation illustrated in the image 301. On the other hand, for example, an image 302 in FIG. 3 illustrates an example of an image obtained by applying a conventional technique for reducing a fluctuation by cutting off the wavelength band of visible light. For example, in the case of the conventional technique for reducing a fluctuation by cutting off the wavelength band of visible light, for example, it is possible to correct a strong fluctuation, but this results in a monochrome image as illustrated in the image 302, and color information becomes lost. That is, in the case of the conventional technique, for example, information regarding the differences between colors is lost due to the infrared reflection characteristics of the characters "advertisement" and the signboard, and the characters on the signboard are illegible. In contrast, based on the correction apparatus according to the present exemplary embodiment, for example, as illustrated in the image 304 in the case of the fluctuation "medium", an image is obtained in which a fluctuation is reduced to some extent while more color information than that of the image 302 remains. For example, as illustrated in the image 303 in the case of the fluctuation "strong", an image is obtained in which a fluctuation is excellently reduced, as well as more color information than that of the image 302 remains. Further, based on the correction apparatus according to the present exemplary embodiment, for example, also in the case of the fluctuation "weak", it is possible to leave more color information while also appropriately reducing a fluctuation.

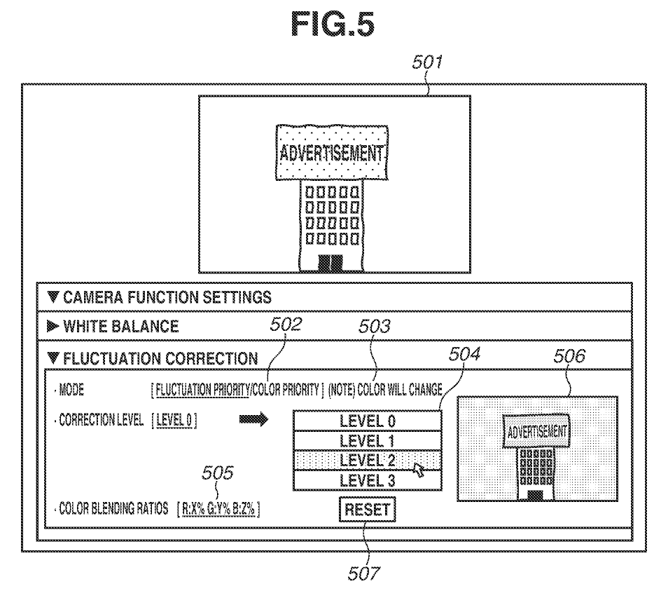

FIG. 5 is a diagram illustrating an example of a GUI screen for making various settings of the imaging apparatus including the correction apparatus (the surveillance camera) according to the present exemplary embodiment.

This GUI screen is a screen displayed on a monitor mounted on the imaging apparatus or a monitor connected to the imaging apparatus via a communication network by the CPU 103 executing the program according to the present exemplary embodiment.

In the example of the GUI screen in FIG. 5, an image 501 is an example of an image of a scene similar to the image 301 in FIG. 3 where a fluctuation occurs before the correction process according to the present exemplary embodiment is performed.

On the GUI screen in FIG. 5, a mode selection user interface (UI) 502 is a UI used by the user to select in what priority the fluctuation is to be corrected. For example, if an item "fluctuation priority" is selected by the user in the mode selection UI 502, the CPU 103 performs processing for effectively reducing the fluctuation by selecting wavelength bands according to the present exemplary embodiment as described above. There is a possibility that the color deviates by correcting the fluctuation by selecting wavelength bands, and therefore, if "fluctuation priority" is selected, the CPU 103 generates and displays a message 503 for notifying the user that there is a possibility that the color will deviate. On the other hand, in a case where the color deviates by correcting the fluctuation by selecting wavelength bands, the user indicates an item "color priority" and thereby can also select an image with less color deviation. If the item "color priority" is selected by the user, the CPU 103 may correct the fluctuation using a general technique for smoothing images in the time direction.

On the GUI screen in FIG. 5, a correction level setting UI 504 is a UI used by the user to set the correction level of the fluctuation by the correction process according to the present exemplary embodiment. In the correction level setting UI 504, fluctuation correction levels, namely a level 0 to a level 3, are prepared. The level 0 indicates "no correction". The level 1 indicates a fluctuation correction level corresponding to the fluctuation "weak". The level 2 indicates a fluctuation correction level corresponding to the fluctuation "medium". The level 3 indicates a fluctuation correction level corresponding to the fluctuation "strong".

On the GUI screen in FIG. 5, a color blending ratio UI 505 displays the signal ratios according to the correction level set in the correction level setting UI 504. That is, the color blending ratio UI 505 displays the signal ratios of the wavelength bands of a red signal, a green signal, and a blue signal to be used to generate an output image. To the color blending ratio UI 505, the user can also directly input a numerical value. In the color blending ratio UI 505, a reset button 507 is also prepared. If the reset button 507 is pressed, the signal ratios return to the ratios set in advance.

On the GUI screen in FIG. 5, as an image 506, the image 303 or 304 illustrated in and generated based on the correction level in the correction level setting UI 504 and the color blending ratios in the color blending ratio UI 505 is displayed.

Next, an imaging apparatus including a correction apparatus according to a second exemplary embodiment is described. In the first exemplary embodiment, a description has been given of an example where wavelength bands related to the generation of an output image are selected based on fluctuation information acquired from an input image, specifically, an example where the presence or absence of the use of a red signal, a green signal, and a blue signal or the signal ratios of the red signal, the green signal, and the blue signal are changed. That is, in the first exemplary embodiment, an example is taken where an output image is generated using wavelength bands selected from an input image. In contrast, in the second exemplary embodiment, an example is taken where the imaging apparatus including the correction apparatus includes optical filters capable of changing optical characteristics, or a lens in which a different function can be set with respect to each wavelength of light. In the second exemplary embodiment, an example is described where wavelength bands related to the generation of an output image are selected by switching the optical filters or the functions of the lens according to fluctuation information.

As described above in the first exemplary embodiment, the presence or absence of the use of electric signals constituting image signals or the ratios of the signals are changed, whereby it is possible to leave color information while reducing a fluctuation. However, for example, in a case where a stronger fluctuation occurs, and if an electric signal on the short-wavelength band side is left even by the slightest amount, there is a possibility that the influence of the fluctuation remains. That is, in a case where a strong fluctuation occurs, and if a blue signal on the short wavelength side likely to be influenced by a fluctuation is left even by the slightest amount, a somewhat large fluctuation remains in an output image.

Accordingly, in the second exemplary embodiment, the imaging apparatus includes optical filters capable of changing optical characteristics, or a lens in which a different function can be set with respect to each wavelength of light, and the imaging apparatus switches the optical filters or the functions of the lens according to fluctuation information, thereby cutting the short wavelength side likely to be influenced by a fluctuation when an image is captured. In the second exemplary embodiment, the optical filters or the functions of the lens are switched in a stepwise manner according to fluctuation information, whereby it is possible to leave color information while effectively reducing a fluctuation.

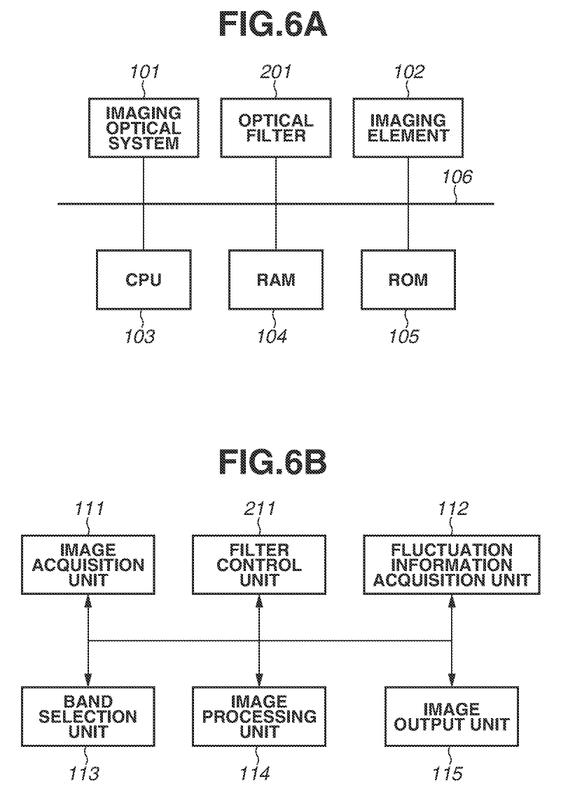

FIG. 6A is a block diagram illustrating an example of the configuration of the imaging apparatus including the functions of the correction apparatus according to the second exemplary embodiment. The imaging apparatus illustrated in FIG. 6A includes an optical filter 201 in addition to an imaging optical system 101, an imaging element 102, a CPU 103, a RAM 104, and a ROM 105 similar to the above. These components are electrically connected together via a bus 106. FIG. 6B is a block diagram illustrating the functional configuration of the correction apparatus included in the imaging apparatus according to the second exemplary embodiment. As illustrated in FIG. 6B, the correction apparatus according to the second exemplary embodiment includes a filter control unit 211 in addition to functional units such as an image acquisition unit 111, a fluctuation information acquisition unit 112, a band selection unit 113, an image processing unit 114, and an image output unit 115 similar to the above. In the configurations in FIGS. 6A and 6B, components similar to those in the first exemplary embodiment are designated by the same reference signs, and are not described. Components different from the first exemplary embodiment are described below.

In the imaging apparatus according to the second exemplary embodiment, the optical filter 201 includes at least one or more of an infrared cut-off filter, a visible light cut-off filter, and a band-pass filter. The infrared cut-off filter is an optical filter that attenuates a long-wavelength band on the infrared light side and transmits a wavelength band on the visible light side. The visible light cut-off filter is an optical filter that attenuates a wavelength band shorter than a certain wavelength band and transmits a long-wavelength band of the wavelength band of visible light. The band-pass filter is an optical filter that transmits only a particular wavelength band. The particular wavelength band transmitted through the band-pass filter may be a single wavelength band, or may be a plurality of wavelength bands. The filters included in the optical filter 201 are placed so that the filters can be inserted onto and removed from the optical axis of the imaging optical system 101 included in the imaging apparatus. The filters are individually inserted and removed by a driving unit (not illustrated) under control of the filter control unit 211. For example, if the infrared cut-off filter is inserted onto the optical axis of the imaging optical system 101, it is possible to attenuate an infrared light component of light incident on the imaging element 102 and reduce the influence of the infrared light component on image signals captured by the imaging element 102.

In the present exemplary embodiment, the visible light cut-off filter, the infrared cut-off filter, and the band-pass filter included in the optical filter 201 are not limited to a single visible light cut-off filter, a single infrared cut-off filter, and a single band-pass filter, and may be a plurality of visible light cut-off filters, a plurality of infrared cut-off filters, and a plurality of band-pass filters. For example, the visible light cut-off filter may include two or more visible light cut-off filters that attenuate different wavelength bands. Similarly, the band-pass filter may include two or more band-pass filters that transmit different wavelength bands. The band-pass filter may include a so- called dual band-pass filter that transmits two different wavelength bands. As described above, for example, the optical filter 201 includes an infrared cut-off filter, two or more visible light cut-off filters, and two or more band-pass filters and is configured to use the plurality of filters by optionally combining the plurality of filters. In the present exemplary embodiment, for example, the optical filter 201 including five filters, namely an infrared cut-off filter, two visible light cut-off filters that attenuate different wavelength bands, and two band-pass filters that transmit different wavelength bands, is taken as an example. As a matter of course, the number of filters is not limited to five so long as wavelength bands can be switched in a stepwise manner by optionally combining the plurality of filters.

The filter control unit 211 controls the insertion and removal of the infrared cut-off filter, the two visible light cut-off filters, and the two band-pass filters included in the optical filter 201, thereby optionally combining the filters and placing the filters on the optical axis of the imaging optical system 101. The filter control unit 211 may control the insertion and removal of the filters according to a setting indicated by the user, or can also automatically control the insertion and removal of the filters according to information regarding a fluctuation. That is, in the second exemplary embodiment, the selection of wavelength bands by the band selection unit 113 is achieved by the filter control unit 211 controlling the insertion and removal of the filters included in the optical filter 201.

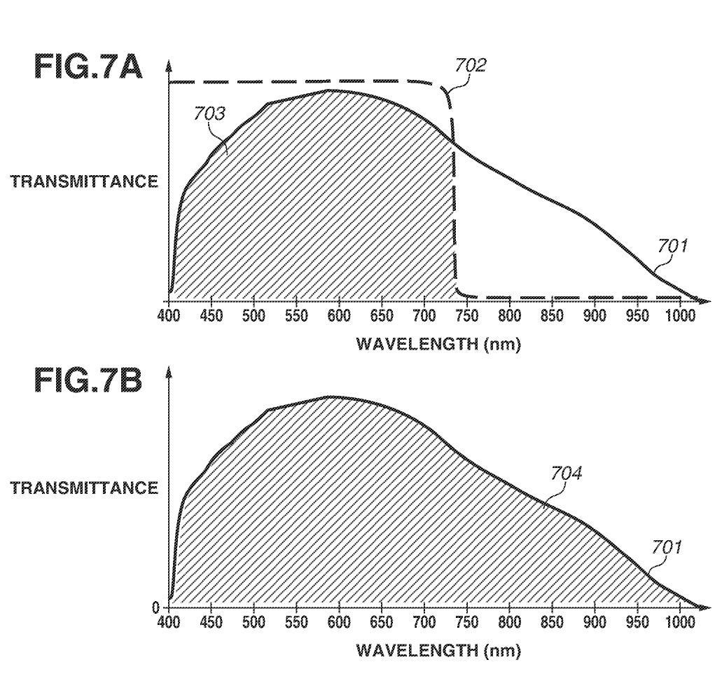

FIGS. 7A and 7B are diagrams illustrating examples of the transmittance of the infrared cut-off filter included in the optical filter 201. The horizontal axis represents the wavelength. The vertical axis represents the transmittance. A spectral curve 701 drawn by a solid line in FIGS. 7A and 7B is the spectral sensitivity curve of the imaging element 102.

In the case of an imaging mode of a general surveillance camera, an infrared cut-off filter 702 having an optical characteristic as indicated by a dashed line in FIG. 7A is inserted onto the optical axis. If the infrared cut-off filter 702 is inserted in this manner, an area having sensitivity to the imaging element 102 is an area indicated by a shaded portion 703 in FIG. 7A. If, on the other hand, the infrared cut-off filter 702 is removed, an area having sensitivity to the imaging element 102 is an area indicated by a shaded portion 704 in FIG. 7B. In the present exemplary embodiment, particularly, the infrared cut-off filter may be used simultaneously with other filters (the visible light cut- off filters or the band-pass filters) included in the optical filter 201, or may be exclusive relative to other filters and removed. For example, to reduce a strong fluctuation, the user may also select a band-pass filter capable of cutting the short-wavelength band side most, or the band selection unit 113 may also automatically select a filter capable of leaving color information while reducing a fluctuation, according to information regarding a fluctuation.

In any of these cases, the infrared cut-off filter can be removed or can be used simultaneously with other filters.

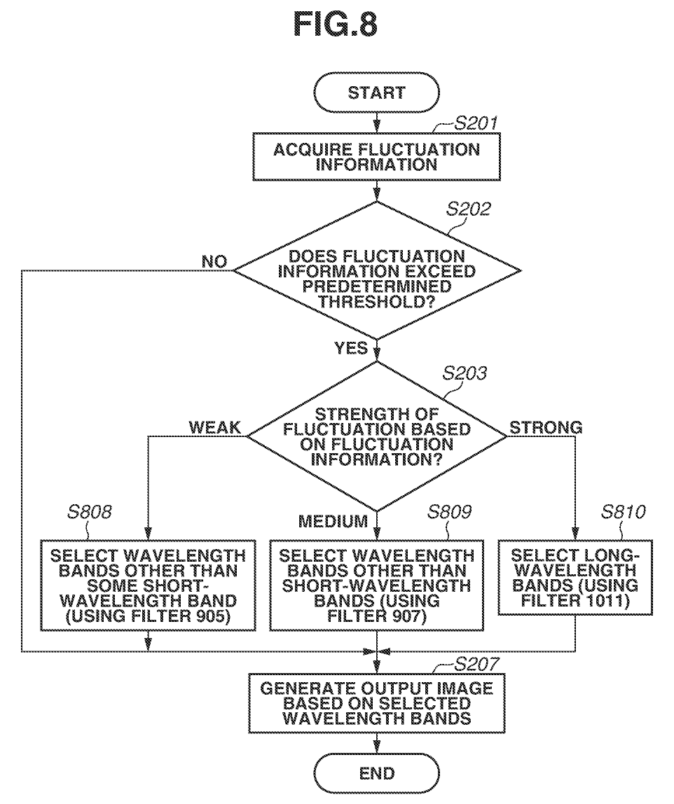

FIG. 8 is a flowchart of a correction process according to the second exemplary embodiment. In the flowchart in FIG. 8, processing steps similar to those in the flowchart in FIG. 2 are designated by the same reference signs as those in FIG. 2, and are not described. Processing steps different from the flowchart in FIG. 2 are described below.

In step S203 after steps S201 and S202 similar to those in the flowchart in FIG. 2, the fluctuation information acquisition unit 112 performs classification according to the strength of the fluctuation similarly to the above. Then, in the second exemplary embodiment, if the strength of the fluctuation is the fluctuation "weak", the processing proceeds to step S808. If the strength of the fluctuation is the fluctuation "medium", the processing proceeds to step S809. If the strength of the fluctuation is the fluctuation "strong", the processing proceeds to step S810.

In step S808, the band selection unit 113 selects wavelength bands related to the generation of an output image corresponding to the case of the fluctuation "weak". In the second exemplary embodiment, the selection of wavelength bands by the band selection unit 113 is achieved by the filter control unit 211 controlling the insertion and removal of the filters included in the optical filter 201. In the present exemplary embodiment, in the case of the fluctuation "weak", the band selection unit 113 selects wavelength bands other than some short-wavelength band as the wavelength bands related to the generation of the output image among the wavelength bands of light incident on the imaging apparatus. Thus, the filter control unit 211 performs control to insert a filter capable of transmitting wavelength bands other than some short- wavelength band among the wavelength bands of light incident on the imaging apparatus among the filters of the optical filter 201 onto the optical axis of the imaging optical system 101.

In the present exemplary embodiment, in the case of the fluctuation "weak", the visible light cut-off filters are used as the filter capable of transmitting wavelength bands other than some short-wavelength band among the wavelength bands of light incident on the imaging apparatus.

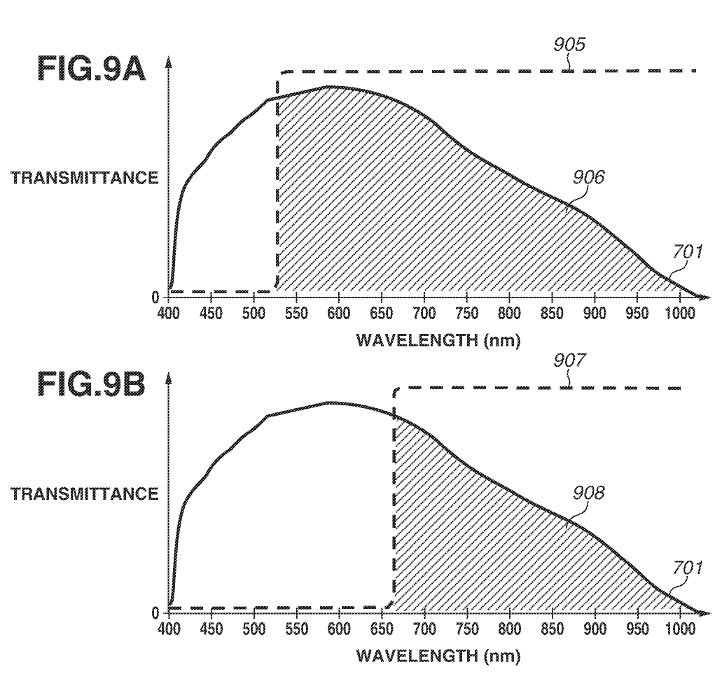

FIGS. 9A and 9B are diagrams illustrating examples of the transmittances of the visible light cut-off filters. The vertical axis represents the transmittance of each filter. The horizontal axis represents the range of 400 nm to 1000 nm of the wavelength of light received by the imaging element 102. A spectral curve 701 is the spectral sensitivity curve of the imaging element 102 similarly to the above. In the present exemplary embodiment, as the visible light cut-off filters, two visible light cut-off filters that attenuate different wavelength bands, namely first and second visible light cut-off filters, are used. A dashed line in FIG. 9A indicates the optical characteristic of a first visible light cut-off filter 905. A dashed line in FIG. 9B indicates the optical characteristic of a second visible light cut-off filter 907. That is, the first visible light cut-off filter 905 is a filter having an optical characteristic that attenuates the short wavelength side of a wavelength near a wavelength of 530 nm and transmits the long wavelength side of the wavelength. According to the first visible light cut-off filter 905, an area having sensitivity to the imaging element 102 is an area indicated by a shaded portion 906 in FIG. 9A. The second visible light cut-off filter 907 is a filter having an optical characteristic that attenuates the short wavelength side of a wavelength near a wavelength of 660 nm and transmits the long wavelength side of the wavelength. According to the second visible light cut-off filter 907, an area having sensitivity to the imaging element 102 is an area indicated by a shaded portion 908 in FIG. 9B.

Between these two visible light cut-off filters, the second visible light cut-off filter 907 that attenuates the short wavelength side more has a greater effect of reducing a fluctuation. Meanwhile, the amount of light transmitted through the second visible light cut-off filter 907 decreases compared to the amount of light transmitted through the first visible light cut-off filter 905. Thus, a decrease in the exposure or the luminance and the loss of the color information are greater in the second visible light cut-off filter 907. Thus, in the case of the fluctuation "weak", to leave more color information and reduce a decrease in the exposure or the luminance, the band selection unit 113 selects wavelength bands using the first visible light cut-off filter 905.

That is, in the case of the fluctuation "weak", the filter control unit 211 performs control to insert the first visible light cut-off filter 905 onto the optical axis of the imaging optical system 101. After the filter control unit 211 controls the insertion and removal of the optical filter 201 in step S808, the processing proceeds to step S207.

In step S809, the band selection unit 113 selects wavelength bands related to the generation of an output image corresponding to the case of the fluctuation "medium". In the second exemplary embodiment, the filter control unit 211 controls the insertion and removal of the filters included in the optical filter 201 according to the selected wavelength bands. In the present exemplary embodiment, in the case of the fluctuation "medium", the band selection unit 113 selects wavelength bands by removing more wavelength bands than the short-wavelength band removed in the case of the fluctuation "weak" among the wavelength bands of light incident on the imaging apparatus. Thus, the filter control unit 211 performs control to insert a filter capable of transmitting wavelength bands other than more wavelength bands than the short-wavelength band removed in the case of the fluctuation "weak" among the filters of the optical filter 201 onto the optical axis of the imaging optical system 101.

In the present exemplary embodiment, in a case where the first visible light cut-off filter 905 illustrated in FIG. 9 is selected in the case of the fluctuation "weak", and if the strength of the fluctuation is the fluctuation "medium", the second visible light cut-off filter 907 illustrated in FIG. 9B is selected. That is, the second visible light cut-off filter 907 is selected, whereby the output image is generated based on wavelength bands after more wavelength bands than that removed by the first visible light cut-off filter 905 are removed. After the filter control unit 211 controls the insertion and removal of the optical filter 201 in step S809, the processing proceeds to step S207.

In step S810, the band selection unit 113 selects wavelength bands related to the generation of an output image corresponding to the case of the fluctuation "strong". In the second exemplary embodiment, the filter control unit 211 controls the insertion and removal of the filters included in the optical filter 201 according to the selected wavelength bands. In the present exemplary embodiment, in the case of the fluctuation "strong", the band selection unit 113 selects wavelength bands by removing more wavelength bands than the short-wavelength bands removed in the cases of the fluctuation "weak" and the fluctuation "medium" among the wavelength bands of light incident on the imaging apparatus. Thus, the filter control unit 211 performs control to insert a filter capable of transmitting wavelength bands other than more wavelength bands than those removed in the cases of the fluctuation "weak" and the fluctuation "medium" among the filters of the optical filter 201 onto the optical axis of the imaging optical system 101.

In the present exemplary embodiment, as a filter in the case of the fluctuation "strong", for example, a visible light cut-off filter (not illustrated) capable of removing more short wavelength bands than those removed by the second visible light cut-off filter 907 illustrated in FIG. 9B may be used. However, in a case where the visible light cut-off filter capable of removing more short wavelength bands than those removed by the second visible light cut-off filter 907 is used, there is a possibility that the color information becomes more lost, and the exposure or the luminance decreases more than in a case where the second visible light cut-off filter 907 is used.

Thus, in the present exemplary embodiment, in the case of the fluctuation "strong", the band-pass filters are used as a filter capable of reducing the loss of the color information and a decrease in the exposure or the luminance while effectively reducing the fluctuation.

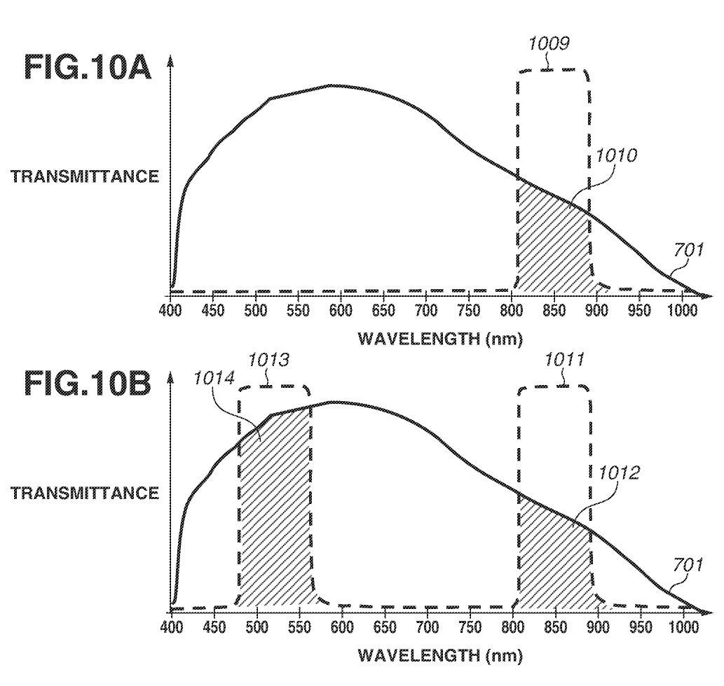

FIGS. 10A and 10B are diagrams illustrating examples of the transmittances of the band-pass filters. The vertical axis represents the transmittance of each filter. The horizontal axis represents the wavelength of light received by the imaging element 102. A spectral curve 701 is the spectral sensitivity curve of the imaging element 102 similarly to the above. In the present exemplary embodiment, as the band-pass filters, two band-pass filters that transmit different wavelength bands are used. A dashed line in FIG. 10A indicates the optical characteristic of a first band-pass filter 1009. Two dashed lines in FIG. 10B indicate the optical characteristics of a second band-pass filter that is a dual band-pass filter. In the present exemplary embodiment, the first band-pass filter 1009 is a band-pass filter having an optical characteristic that transmits only a wavelength band range near wavelengths of 800 nm to 900 nm. According to the first band-pass filter 1009, an area having sensitivity to the imaging element 102 is an area indicated by a shaded portion 1010 in FIG. 10A. The second band-pass filter is a dual band-pass filter including a filter 1011 having an optical characteristic that transmits a wavelength band range near wavelengths of 800 nm to 900 nm, and a filter 1013 having an optical characteristic that transmits a wavelength band range near wavelengths of 470 nm to 570 nm. According to the second band-pass filter, areas having sensitivities to the imaging element 102 are areas indicated by shaded portions 1012 and 1014 in FIG. 10B.

The filter capable of more effectively reducing the fluctuation is the first band- pass filter 1009. However, in a case where the first band-pass filter 1009 is used, the loss of the color information and a decrease in the exposure or the luminance are greater than in a case where the second band-pass filter is used. Thus, in the present exemplary embodiment, to leave as much color information as possible and also reduce a decrease in the exposure or the luminance, the second band-pass filter that is a dual band-pass filter also including the filter 1013 that transmits a part of the wavelength band of visible light is used. For example, in a case where the user gives an instruction to give priority to a reduction in the fluctuation over the loss of the color information or a decrease in the exposure or the luminance, the first band-pass filter 1009 may be selected. After the filter control unit 211 controls the insertion and removal of the optical filter 201 in step S810, the processing proceeds to step S207.

In the second exemplary embodiment, in S207 after step S808, S809, or S810, the image processing unit 114 performs a generation process for generating the output image based on the wavelength bands selected in steps S808, S809, or S810.

That is, the image processing unit 114 according to the second exemplary embodiment generates the output image from the image captured by the imaging element 102 via the filter selected in any of steps S808, S809, and S810.

For example, if the visible light cut-off filter 905 is used corresponding to the fluctuation "weak" in step S808, the color of the image deviates by an amount corresponding to the attenuation of a blue component on the short wavelength side by the visible light cut-off filter 905, and the luminance or the exposure of the image also decreases. Thus, in step S207 in the second exemplary embodiment, the image processing unit 114 corrects the color that deviates due to the optical characteristic of the visible light cut-off filter 905, and corrects the luminance or the exposure. Then, the image output unit 115 outputs an image after the corrections as the output image.

For example, the image processing unit 114 calculates the white balance gain again, thereby bringing the output image close to the color reproduction of the original input image. If the luminance decreases due to the decrease in the signal, the image processing unit 114 adds an offset amount corresponding to the amount of the decrease in the signal. For example, the image processing unit 114 may fix the white balance and increase or decrease the white balance by an offset amount corresponding to the amount of change in the ratio of the signal, thereby bringing the output image close to the color reproduction of the original image. Even if the image processing unit 114 brings the output image close to the color reproduction of the original input image, there is a possibility that the color of the output image does not completely match the original color. Thus, there can also be a case where other functions of the color system are restricted from being used.

In the second exemplary embodiment, the optical filter 201 attenuates a short wavelength component such as a blue component of incident light. However, image signals output from the imaging element 102 include a blue signal, and an output image is generated from the image signals. A decrease in the signal due to the attenuation of the short wavelength component by the optical filter 201 can be corrected by, for example, adjusting the white balance gain. That is, according to the second exemplary embodiment, the optical filter 201 attenuates a component likely to be influenced by a fluctuation and then amplifies a signal by adjusting the gain, and therefore, a fluctuation is not increased by adjusting the gain. Thus, according to the second exemplary embodiment, it is possible to leave more color information than that in the first exemplary embodiment while reducing more fluctuations than that in the first exemplary embodiment.

As described above, according to the second exemplary embodiment, the short wavelength side likely to be influenced by a fluctuation is cut by controlling an optical filter in a stepwise manner according to fluctuation information, whereby it is possible to leave color information while reducing a fluctuation.

Although in each of the above exemplary embodiments, an example has been taken where a correction apparatus is applied to an imaging apparatus, the correction apparatus may be achieved by an information processing apparatus such as a personal computer or a smartphone connected to the imaging apparatus. In this case, the imaging apparatus also outputs information indicating the presence or absence of the influence of a fluctuation on an input image with raw image signals captured by an imaging unit and imaging parameters indicating the exposure time, the frame rate, and the exposure setting value to the information processing apparatus (the correction apparatus). Then, a CPU of the information processing apparatus executes the program for the correction process according to the present exemplary embodiment using the image signals, the imaging parameters, and the information indicating the presence or absence of the influence of a fluctuation sent from the imaging apparatus, thereby achieving the correction process as described above. Also in a case where the correction apparatus is achieved by the information processing apparatus connected to the imaging apparatus, it is possible to apply an example where an optical filter as in the second exemplary embodiment is mounted on the imaging apparatus. In this case, information regarding the optical filter of the imaging apparatus as in the second exemplary embodiment is also sent to the information processing apparatus. The information regarding the optical filter of the imaging apparatus as in the second exemplary embodiment may be input by a user of the information processing apparatus or the imaging apparatus.

Although in each of the above exemplary embodiments, an example has been taken where a correction apparatus is applied to a surveillance camera, the present disclosure is not limited to this example. An imaging apparatus on which the correction apparatus is mounted may be any camera that captures an image likely to be influenced by a fluctuation due to the atmosphere, and for example, may be a general lens- integrated camera or interchangeable-lens camera capable of telephoto imaging.

The present disclosure can also be achieved by the process of supplying a program for achieving one or more functions of the above exemplary embodiments to a system or an apparatus via a network or a storage medium, and of causing one or more processors of a computer of the system or the apparatus to read and execute the program. The present disclosure can also be achieved by a circuit (e.g., an application-specific integrated circuit (ASIC)) for achieving the one or more functions. All the above exemplary embodiments merely illustrate specific examples for carrying out the present disclosure, and the technical scope of the present disclosure is not to be interpreted in a limited manner based on these exemplary embodiments. That is, the present disclosure can be carried out in various ways without departing from the technical idea or the main feature of the present disclosure.

Embodiment(s) of the present disclosure can also be realized by a computer of a system or apparatus that reads out and executes computer executable instructions (e.g., one or more programs) recorded on a storage medium (which may also be referred to more fully as a 'non-transitory computer-readable storage medium') to perform the functions of one or more of the above-described embodiment(s) and/or that includes one or more circuits (e.g., application specific integrated circuit (ASIC)) for performing the functions of one or more of the above-described embodiment(s), and by a method performed by the computer of the system or apparatus by, for example, reading out and executing the computer executable instructions from the storage medium to perform the functions of one or more of the above-described embodiment(s) and/or controlling the one or more circuits to perform the functions of one or more of the above-described embodiment(s). The computer may comprise one or more processors (e.g., central processing unit (CPU), micro processing unit (MPU)) and may include a network of separate computers or separate processors to read out and execute the computer executable instructions. The computer executable instructions may be provided to the computer, for example, from a network or the storage medium. The storage medium may include, for example, one or more of a hard disk, a random-access memory (RAM), a read only memory (ROM), a storage of distributed computing systems, an optical disk (such as a compact disc (CD), digital versatile disc (DVD), or Blu-ray Disc^{TM} (BD)), a flash memory device, a memory card, and the like.

While the present disclosure has been described with reference to embodiments, it is to be understood that the present disclosure is not limited to the disclosed embodiments. The scope of the following claims is to be accorded the broadest interpretation so as to encompass all such modifications and equivalent structures and functions.

This application claims the benefit of Japanese Patent Application No. 2024- 106201, filed July 1, 2024, which is hereby incorporated by reference herein in its entirety.

What is claimed is:

1. A correction apparatus comprising:
at least one memory storing instructions; and
at least one processor that, upon execution of the stored instructions, cause the correction apparatus to function as:
a fluctuation information acquisition unit configured to acquire fluctuation information related to fluctuation of an input image;
a band selection unit configured to select a wavelength band related to a generation of an output image according to the fluctuation information; and
an image processing unit configured to perform predetermined image processing on the input image based on the selected wavelength band to generate the output image.

2. The correction apparatus according to claim 1, wherein the band selection unit selects a wavelength band related to the generation of the output image from among wavelength bands of the input image based on the fluctuation information.

3. The correction apparatus according to claim 1, wherein the band selection unit selects a wavelength band related to the generation of the output image by changing ratios of signals of respective bands among wavelength bands of the input image based on the fluctuation information.

4. The correction apparatus according to claim 1, wherein the band selection unit selects a wavelength band related to the generation of the output image by, based on the fluctuation information, selecting any one or more optical filters from among a plurality of optical filters that transmit or cut off different wavelength bands in wavelength bands of incident light.

5. The correction apparatus according to claim 4, wherein the optical filters include one or more of an infrared cut-off filter, a visible light cut-off filter, and a band- pass filter.

6. The correction apparatus according to claim 5, wherein the band-pass filter includes a dual band-pass filter that transmits two different wavelength bands.

7. The correction apparatus according to claim 5, wherein the band selection unit selects a wavelength band related to the generation of the output image by, based on the fluctuation information, selecting any one visible light cut-off filter from among two or more visible light cut-off filters that cut off different wavelength bands or selecting any one band-pass filter from among two or more band-pass filters that transmit different wavelength bands.

8. The correction apparatus according to claim 1, wherein the information acquisition unit acquires the fluctuation information indicating an amount of the fluctuation based on the input image.

9. The correction apparatus according to claim 8, wherein the band selection unit adjusts the wavelength band so that the greater the amount of the fluctuation is, the longer wavelength band is selected.

10. The correction apparatus according to claim 8, wherein the information acquisition unit acquires the fluctuation information indicating the amount of the fluctuation based on a difference in pixels of interest between the input images successive in chronological order.

11. The correction apparatus according to claim 8, wherein the information acquisition unit acquires a cycle of fluctuation corresponding to the number of frames in a case where an accumulated value of differences between successive frames of the input images in chronological order is greater than or equal to a predetermined value, as the fluctuation information indicating the amount of the fluctuation.

12. The correction apparatus according to claim 8, wherein the information acquisition unit acquires a proportion of an area where the fluctuation occurs in the input image, as a fluctuation occurrence probability, and acquires the fluctuation occurrence probability as the fluctuation information indicating the amount of the fluctuation.

13. The correction apparatus according to claim 1, wherein the fluctuation information includes at least either information that disables correction of the fluctuation based on at least either a lapse of time or an environment, or information that disables the correction of the fluctuation based on a result of estimating illuminance.

14. The correction apparatus according to claim 1, wherein the predetermined image processing includes processing of correcting the fluctuation using a plurality of the input images in chronological order.

15. The correction apparatus according to claim 13, wherein the information acquisition unit acquires the fluctuation information based on a correction strength in the image processing of correcting the fluctuation.

16. The correction apparatus according to claim 1, wherein the predetermined
image processing includes processing of correcting a color deviation of an image based on the selected wavelength band.

17. The correction apparatus according to claim 1, wherein the predetermined image processing includes processing of correcting luminance or exposure of an image based on the selected wavelength band.

18. A correction method comprising:
acquiring fluctuation information related to fluctuation of an input image;
selecting a wavelength band related to a generation of an output image according to the fluctuation information; and
performing predetermined image processing on the input image based on the selected wavelength band to generate the output image.

19. A non-transitory computer-readable storage medium storing a program for causing a computer to execute a method comprising:
acquiring fluctuation information related to fluctuation of an input image;
selecting a wavelength band related to a generation of an output image according to the fluctuation information; and
performing predetermined image processing on the input image based on the selected wavelength band to generate the output image.
